(19) United States
(12) Patent Application Publication
(10) Pub. No.: US 2003/0076911 A1
(43) Pub. Date: Apr. 24, 2003

(54) Receiver apparatus in stuffing synchronization system

(76) Inventors: Masato Kobayashi, Yokohama (JP); Minoru Tateno, Yokohama (JP); Yasushi Yoshino, Yokohama (JP); Hideaki Koyano, Yokohama (JP); Taturu Iwaoka, Yokohama (JP); Takahiro Kubota, Yokohama (JP); Akio Takayasu, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/066,076

(22) Filed: Jan. 31, 2002

(30) Foreign Application Priority Data
Oct. 19, 2001 (JP) 2001-322445

(51) Int. Cl. H04L 7/00

(52) U.S. Cl. 375/372; 370/505

(57) ABSTRACT

The present invention provides a receiver apparatus for receiving digital data in which stuff data have been inserted by stuffing synchronization. The receiver apparatus has a memory unit having a plurality of memory cells. The digital data other than the stuff data are written in the memory unit in synchronization with a write clock signal, and read from the memory cell in synchronization with a read clock signal. The cycle of the read clock signal is adjusted on the basis of an interval from a reading address to an writing address of the memory cell.

### BACKGROUND OF THE INVENTION

1. Field of the Invention

The present invention relates to a receiver apparatus for receiving digital data in which stuff data have been inserted by stuffing synchronization.

2. Description of the Related Art

There is a stuffing synchronization system (or method) for artificially matching the speeds of a plurality of transmission data streams, and multiplexing and transmitting the plurality of transmission data streams.

With the stuffing synchronization system, in the receiver apparatus, in order to remove the stuff data inserted into the received data and adjust the communication speed, the speed of reading those received data from a buffer memory wherein the received data are temporarily stored is adjusted by a phase-locked loop (PLL).

FIG. 7 is a block diagram of the configuration of a receiver apparatus in a conventional stuffing synchronization system. FIG. 7 diagrams the subsequent stage portion of a demultiplexer, the input data (received data) wherein are data after demultiplexing (bit-unit serial data).

FIGS. 8A and 8B are time charts showing the waveforms of, respectively, input data d of the receiver apparatus shown in FIG. 7, an input clock signal c11, output signal c12 from a frequency divider 105, output signal c13 from a frequency divider 107, output signal c14 from a frequency divider 111, and output signal c15 from a phase comparator 108. FIG. 8A shows the waveforms in the case where stuff data are not inserted, and FIG. 8B shows the waveforms in the case where stuff data S (considered to be 1 byte here) are inserted.

The input data d are input to a serial/parallel converter 101, converted to 8 bits (1 byte) of parallel data, and then input to a buffer memory 102 and destuffer control circuit 104.

The input clock signal c11 has the same frequency as the input data. This input clock signal c11 is divided by the frequency divider 105, and converted to a clock signal c12 having one-eighth the frequency. Hereinafter, the conversion by a frequency divider of an input clock signal to a clock signal having 1/n^{th} the frequency thereof is called “dividing with division ratio n.” This clock signal c12 is input to a write address counter 106 and the frequency divider 107.

The write address counter 106, which is synchronized with the clock signal c12, generates an address signal indicating a write address in the buffer memory 102 and sends the address signal to the buffer memory 102. The address indicated by the address signal is incremented by 1 every time the clock signal c12 is input, returning to the lowest address after the highest address has been reached. Here, the buffer memory 102 has eight 1-byte memory cells (that is, a memory capacity of 8 bytes). Accordingly, the write address counter 106 successively generates address signals from 0 to 7, then returns to 0 after 7 and repeats.

One byte of data from the serial/parallel converter 101 is written to the memory cell indicated by the address signal every time an address signal from the write address counter 106 is input to the buffer memory 102.

The destuffer control circuit 104 checks stuff indicating data that indicate whether or not stuff data are present and the like. When the stuff indicating data indicate the insertion of stuff data, the incrementing of the address of the write address counter 106 and the outputting of the address signal are terminated, whereupon stuff data are not written to the buffer memory 102.

A PLL 120 is formed by the frequency dividers 107 and 111, the phase comparator 108, a low-pass filter (LPF) 109, and a voltage control oscillator (VCO) 110.

The frequency divider 107 divides the clock signal c12 wiht division ratio 8, and sends a clock signal c13 after dividing to the phase comparator 108. When the stuff indicating data indicate the insertion of stuff data, the destuffer control circuit 104 controls the frequency divider 107 so that the frequency divider 107 does not count one clock pulse (indicated by the dashed line in FIG. 8B) of the clock signal c12. As a consequence, as shown in FIG. 8B, the output signal c13 becomes a signal that is one cycle behind the clock signal c12. In other words, the frequency divider 107, when stuff data S are inserted, changes the frequency of the clock signal c13 from ⅛^{th} of the frequency of the clock signal c12 to 1/9^{th} thereof.

The phase comparator 108 finds the phase difference between the clock signal c13 of the frequency divider 107 and the clock signal c14 of the frequency divider 111, and sends a voltage signal corresponding to the phase difference via the low-pass filter (LPF) 109 to the VCO 110. The VCO 110 generates an output clock signal, based on the input phase difference, and outputs the output clock signal to a frequency divider 112 and the subsequent-stage circuitry (not shown).

The frequency divider 112 divides the output clock signal with division ratio 8, and sends the divided clock signal to the frequency divider 111 and to a read address counter 113. The frequency divider 111 divides this clock signal with division ratio 8, and sends the clock signal c14 after frequency-division to the phase comparator 108.

The read address counter 113, which is synchronized with the clock signal from the frequency divider 112, generates an address signal indicating a read address for the buffer memory 102 and sends it to the buffer memory 102. The read address indicated by the address signal is incremented by 1 every time a clock signal is input from the frequency divider 112, returning to the lowest address after the highest address has been reached.

Every time the address signal from the read address counter 113 is input to the buffer memory 102, one byte of input data stored in the memory cell at the read address indicated by the address signal is read out from the buffer memory 102, and sent as parallel data to a parallel/serial converter 103. The parallel/serial converter 103 converts the parallel data from the buffer memory 102 to serial data and outputs those as output data to the subsequent-stage circuitry (not shown).

In this manner the stuff data contained in the input data are removed, and destuffing is effected. Also, the count cycle of the read address counter 113 is adjusted by the PLL 120, and the buffer memory 102 is controlled so that it neither overflows nor underflows.

With this receiver apparatus, however, in cases where the stuff data S are not 1 bit but 1 byte (that is, 8 bits), the cycle of the clock signal c13 input to the phase comparator 108 will increase very rapidly by the measure of 1 cycle of the clock signal c12 (that is, by 8 cycles of the input clock signal c11). As a consequence thereof, there is a danger that jitter will occur in the output clock signal of the VCO 110 at a level that cannot be allowed.

For this reason, receiver apparatuses have been conceived of which gradually change the frequency of the signal input to the phase comparator 108 in order to prevent such jitter. FIG. 9 is a block diagram of the configuration of a conventional receiver apparatus for preventing jitter. The same symbols are used to designate signals and configurational elements that are the same as in FIG. 7, and no detailed description thereof is given here. FIGS. 10A and 10B are time charts showing the waveforms of, respectively, the input data d of the receiver apparatus shown in FIG. 9, the input clock signal c11 to the receiver apparatus shown in FIG. 9, output signal c21 of a frequency divider 202, output signal c22 of a frequency divider 203, output signal c14 of the frequency divider 111, and output signal c23 of the phase comparator 108. FIG. 10A shows the waveforms in the case where stuff data are not inserted, and FIG. 10B shows the waveforms in the case where stuff data S (1 byte) are inserted.

With this receiver apparatus, a PLL 130 is formed by the frequency dividers 111 and 203, phase comparator 108, LPF 109, and VCO 110. By the PLL 130, the counting cycle of the read address counter, that is, the cycle whereby data are read out from the buffer memory 102, is adjusted.

The frequency divider 202, under the control of a destuffing amount smoothing circuit 201, divides the input clock signal c11 with division ratio 8 or 9, and sends the clock signal c21 after frequency-dividing to the frequency divider 203.

When stuff data S are inserted in the input data, a signal (insertion signal) indicating that stuff data S have been inserted is sent from the destuffer control circuit 104 to the destuffing volume smoothing circuit 201.

The destuffing amount smoothing circuit 201 counts the number m of insertion signals sent from the destuffer control circuit 104 across a prescribed number of frames (that is, the number m of stuff data inserted inside the prescribed number of frames, where m is a positive integer). Then, the destuffing amount smoothing circuit 201 sends a number of control signals to the frequency divider 202 to change the division ratio of the frequency divider 202 from 8 to 9, that number corresponding to the data amount counted in the prescribed number of frames. Whereas the stuff data S are 1 byte (which is to say 8 bits), the frequency divider 202 divides the input clock signal c11 wherein 1 clock pulse corresponds to 1 bit. Accordingly, the control signal of the destuffing volume smoothing circuit 201 is divided 8×m times and sent to the frequency divider 202 at time intervals such that jitter does not occur.

When one stuff data S is contained, for example, the control signal is divided 8 times and sent to the frequency divider 202. This time interval is T/2, for example, in a case where the number of insertion signals is counted across 4 frames (where the interval T is taken as the cycle for one frame).

Thus, by changing the division ratio of the frequency divider 202 from 8 to 9, the cycles of the clock signal c21 and clock signal c22 are simply made longer by the measure of 1 cycle of the input clock signal c11 (⅛^{th} of the clock signal c13 shown in FIGS. 8A and 8B as noted earlier), and the change in the input signal of the phase comparator 108 is relaxed. Also, the time interval wherein the division ratio is changed is averaged within a prescribed number of frames, and the difference between the maximum and minimum values of the output frequency of the VCO 110 diminishes. Accordingly, in this receiver apparatus, the amount of jitter generated is reduced.

Nevertheless, with the receiver apparatus diagrammed in FIG. 9, because PLL 130 frequency control is performed only from stuff data of the input data, when a PLL having a low cutoff frequency is used to reduce jitter, if the frequency of stuff data insertion has greatly changed, there is a danger that the buffer memory 102 will overflow due to a delay in PLL following.

Also, in order to make the jitter reduction effect great, it is necessary for the destuffing amount smoothing circuit 201 to count the number of stuff data over a long time period (across many frames), and control the division ratio of the frequency divider 202 over a long time period, whereupon the response of the receiver apparatus is slowed. During this time, in order to prevent the buffer memory 102 from overflowing, the memory capacity of the buffer memory 102 must be made large. For this reason, the size of the buffer memory 102 becomes large, and data delays also become large.

Furthermore, because the destuffing amount smoothing circuit 201 averages stuff data for long time periods, the size of its circuit is increased.

### SUMMARY OF THE INVENTION

An object of the present invention is to reduce the size of the circuitry of the receiver apparatus in a stuffing synchronization system.

Another object of the present invention is to make it possible to adjust the read speed according to the conditions of the writing of data to a memory device for temporarily storing received data and to the conditions of reading such data.

Yet another object of the present invention is to prevent receiver apparatus memory device overflow.

A receiver apparatus according to the present invention is a receiver apparatus for receiving digital data in which stuff data have been inserted by stuffing synchronization, comprising: a memory unit having a plurality of memory cells to which consecutive addresses are assigned; a write unit for designating said addresses in a prescribed order direction and for writing said digital data to the memory cells at the designated addresses, in synchronization with a write clock signal generated on basis of a clock signal synchronized with said digital data; a write controller for prohibiting said write unit from designating said address at least for said stuff data and from writing at least stuff data; a read clock signal generator for generating a read clock signal used for reading out digital data stored in said memory unit; a read unit for successively designating said addresses in said memory unit in said prescribed order direction and for reading out digital data stored in memory cells at the designated addresses in synchronization with said read clock signal; and a read clock signal regulator for adjusting a cycle of said read clock signal based on an interval in said prescribed order direction from an address designated by said read unit to an address designated by said write unit.

According to the present invention, at least part of digital data from which stuff data have been excluded is stored in the memory unit. The data stored in the memory unit are read out with the cycle synchronized to the read clock signal. The cycle of the read clock signal (that is, the read cycle) is controlled on the basis of the interval between the memory unit write address and read address in a prescribed order direction (that is, on the basis of the data write condition and read condition).

Thus, according to the present invention, because the cycle of the read clock signal is controlled on the basis of the condition of data reading to the memory unit and the condition of reading out thereof, there is no need either for a memory for storing data across a plurality of frames or for a circuit to average the frequency of stuff data across a plurality of frames. On the other hand, the condition of data writing to the memory unit and the condition of reading out thereof can be ascertained by a simple circuit (such as an address latch or subtractor or the like) for comparing the relationship between the write address and the read address. Accordingly, based on the present invention, the size of the circuitry of the receiver apparatus can be made smaller.

For example, the read clock signal controller noted earlier effects control so that, when the interval in the prescribed order direction noted above is a predetermined interval, the cycle of the current read clock signal is maintained, when it is shorter than the predetermined interval, the cycle of the read clock signal is made longer than the current cycle, and when it is longer than the predetermined interval, the cycle of the read clock signal is made shorter than the current cycle.

Preferably, said read clock signal regulator performs adjustment of said read clock signals in parts at a plurality of adjustment timings.

By effecting the adjustment of the cycle by dividing it at a plurality of adjustment timings, jitter generation can be reduced even when a phase-locked loop circuit is used in the output clock signal generator.

Also preferably, said read clock signal regulator holds a first table and a second table, and adjusts the cycle of said read clock signal on basis of said first and second tables, said first table associating the interval in said prescribed order direction and an adjustment amount for said cycle, said second table setting a timing for adjusting said cycle by said adjustment amount in one adjustment, or, alternatively, setting timings for adjusting said cycle by dividing said adjustment amount into a plurality, and executing a plurality of adjustments each by said divided adjustment amount.

By dividing the cycle adjustment amount into a plurality and implementing the adjustment of the cycle divided into a plurality of times, jitter generation can be reduced even when a phase-locked loop circuit is used in the output clock signal generator.

Further preferably, intervals between said plurality of timings in said second table are substantially equal time intervals.

In an embodiment according to the present invention, said read clock signal generator comprises: a phase-locked loop circuit having as input signals said write clock signal and a signal resulting from dividing its own output signal with a variable frequency divider; and a frequency divider for dividing an output signal of said phase-locked loop circuit with a division ratio of the same numerical value as the number of bits held in each of said memory cells, and sending the divided signal to said read unit; and said read clock signal regulator increments or decrements a division ratio of said variable frequency divider by 1 from the division ratio of the same numerical value as the number of said bits, and thereby adjusts the cycle of said read clock signal.

Here, “division ratio” is meant (frequency of frequency divider input signal)/(frequency of frequency divider output signal).

### BRIEF DESCRIPTION OF THE DRAWINGS

FIG. 1 is a block diagram of the configuration of a receiver apparatus in a stuffing synchronization system, according to an embodiment of the present invention;

FIG. 2 shows an example configuration of an input data frame input to the receiver apparatus according to an embodiment;

FIG. 3 shows an example of a compensation calculation table;

FIG. 4 shows an example of a compensation pattern table;

FIG. 5 is a time chart showing the waveforms of the input signal and output signal of the variable frequency divider in the receiver apparatus according to an embodiment of the present invention;

FIGS. 6A and 6B are block diagrams showing the configuration of part of the receiver apparatus according to other embodiments of the present invention;

FIG. 7 is a block diagram of the configuration of a receiver apparatus in a conventional stuffing synchronization system;

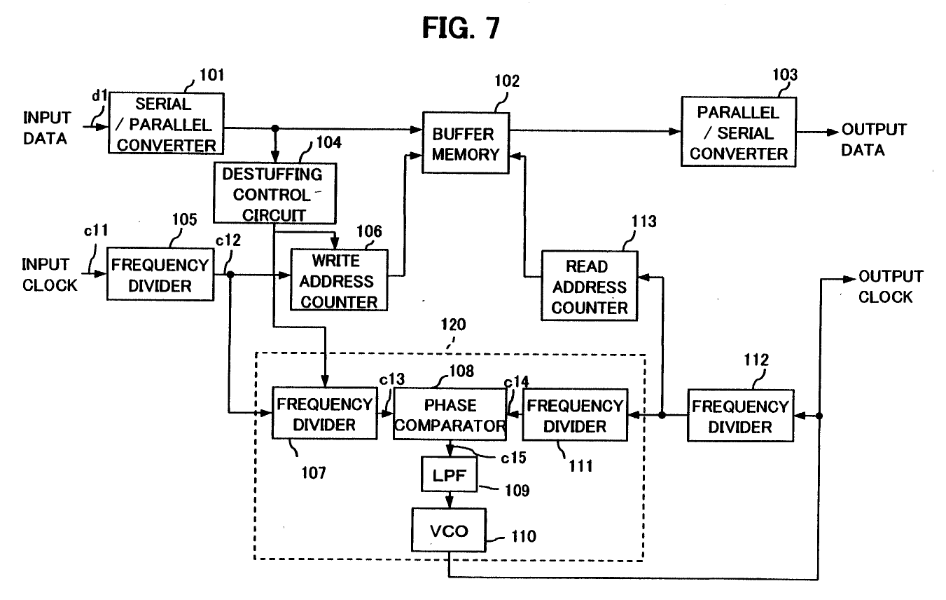

FIGS. 8A and 8B are time charts showing the waveforms of, respectively, input data d, an input clock signal c11, output signal c12, output signal c13, output signal c14, and output signal c15;

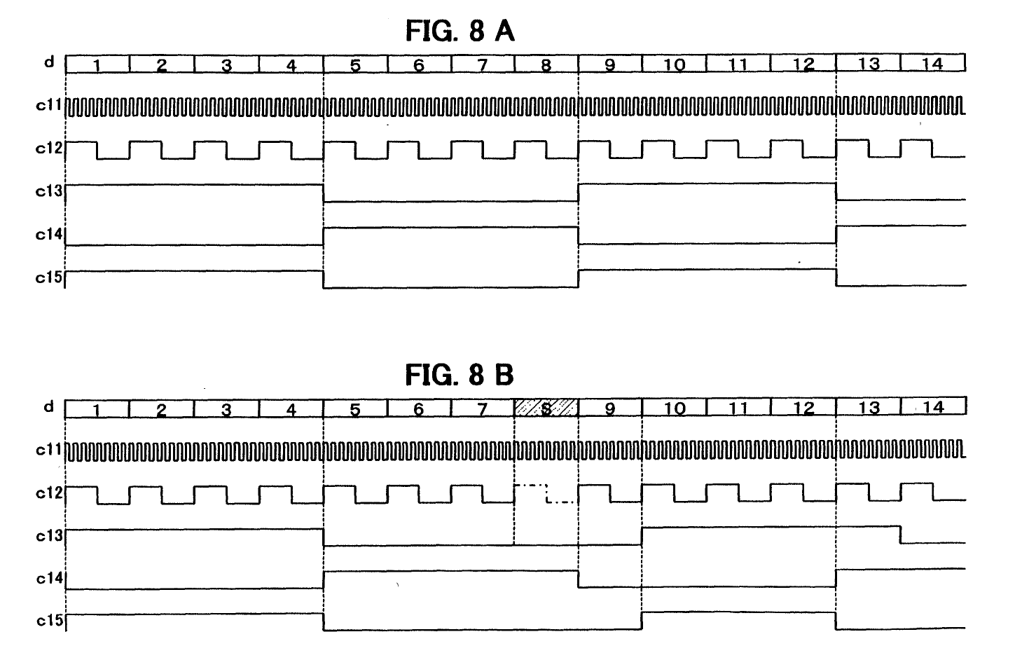

FIG. 9 is a block diagram of the configuration of a conventional receiver apparatus for preventing jitter; and

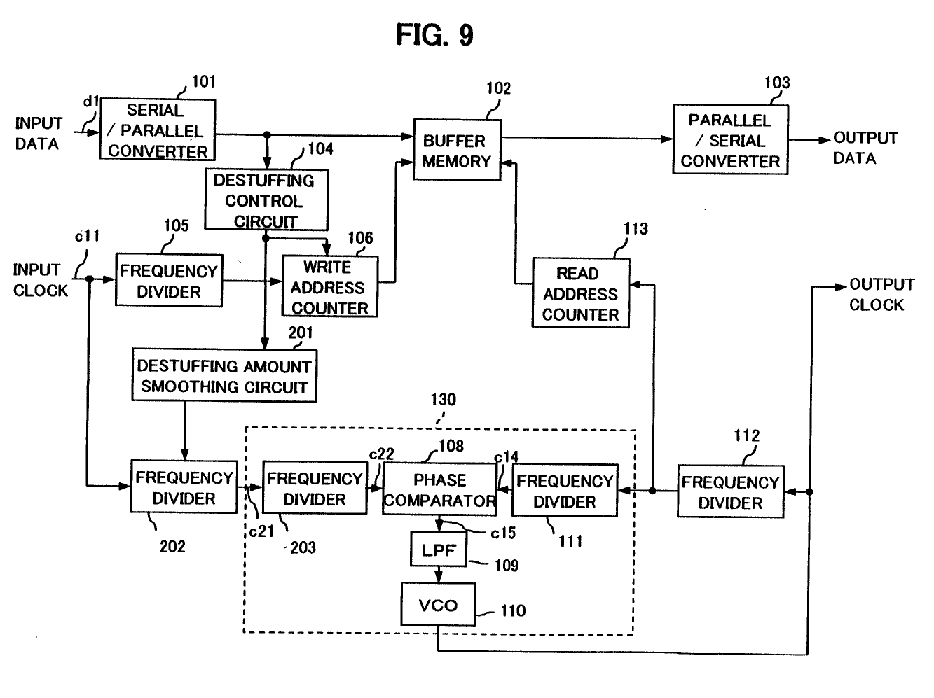

FIGS. 10A and 10B are time charts showing the waveforms of, respectively, the input data d, the input clock signal c11, output signal c21, output signal c22, output signal c14, and output signal c23.

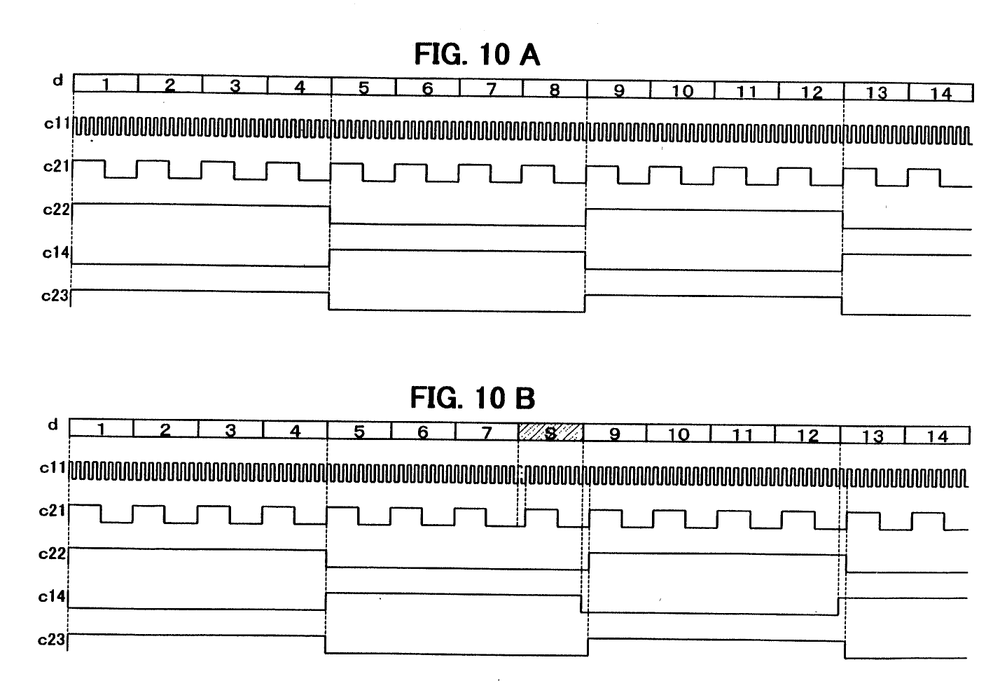

### DESCRIPTION OF THE PREFERRED EMBODIMENTS

An embodiment according to the present invention is described below, but this is one example, and is not meant to limit the technological scope of the present invention.

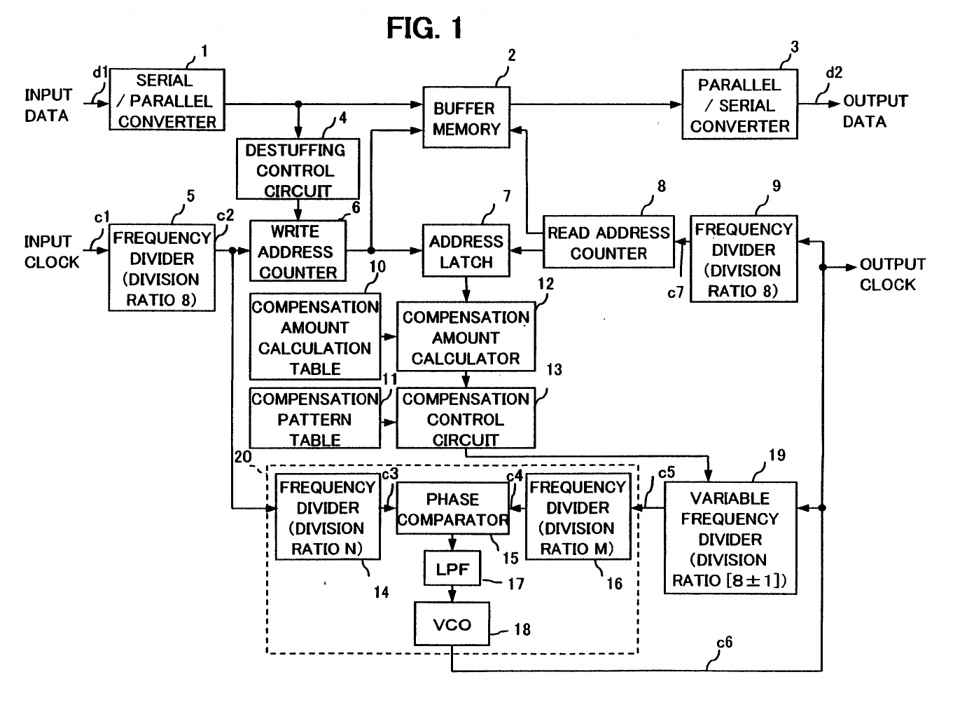

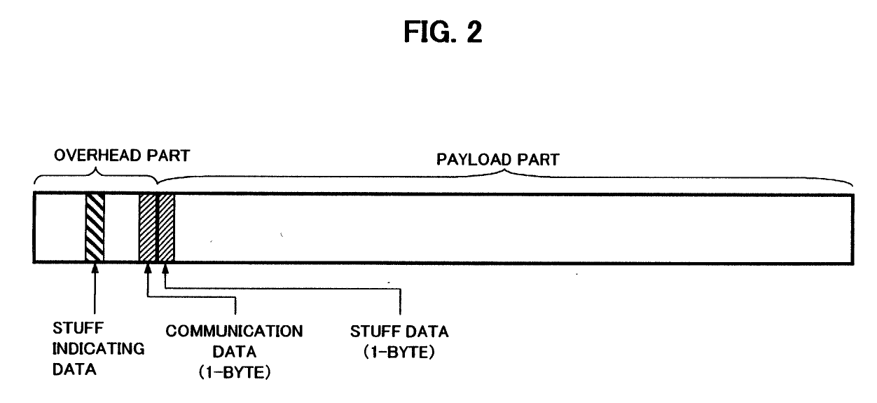

FIG. 1 is a block diagram of the configuration of a receiver apparatus in a stuffing synchronization system, according to an embodiment of the present invention, representing the configuration of the subsequent-stages of a demultiplexing circuit. FIG. 2 shows an example configuration of an input data frame input to the receiver apparatus according to this embodiment.

The frame has 100 bytes, for example, configured by a 10-byte overhead part and a 90-byte payload part.

In the overhead part are placed control data. In those control data are included stuff indicating data (1 byte, for example) indicating whether stuff data are present or not. In the overhead part, moreover, when the communication data to be deployed in the payload part exceeds 90 bytes, an area where the communication data exceeding 90 bytes are placed (being a 1-byte area, as an example, in this embodiment) is secured.

In the payload part are placed the communication data (user data and the like) that are to be stored in a buffer memory, together with stuff data when there is positive stuffing.

This receiver apparatus is oriented to input data having a speed of several hundreds of Mbps (such as 100 Mbps or 150 Mbps), and stuff data are inserted or the like in units of 1 byte (8 bits).

With positive stuffing, for example, in the 90-byte payload part are placed 89 bytes of communication data and 1 byte of stuff data. The position where the stuff data are inserted is predetermined, being, in this embodiment, at the head of the payload part. With negative stuffing, on the other hand, for 91 bytes of communication data, 90 bytes are placed in the payload part, and 1 byte is placed in an area of the overhead part for communication data (being, in this embodiment, the very tail end of the overhead part).

The frame can also be configured by a number of bytes other than 100 bytes. The stuff data, moreover, may be inserted in a number of bytes other than 1 byte (such as 8 bytes, for example), and the area provided in the overhead part for communication data can be for a number of bytes other than 1 byte (such as 8 bytes, for example).

Whether or not such stuff data are present and the distinction between positive and negative stuffing are indicated by stuff indicating data in the overhead part.

The receiver apparatus has a serial/parallel converter 1, a buffer memory 2, a parallel/serial converter 3, a destuffing control circuit 4, frequency dividers 5 and 9, a write address counter 6, an address latch 7, a read address counter 8, a compensation amount calculation table memory 10, a compensation amount calculator 12, a compensation pattern table memory 11, a compensation control circuit 13, a variable frequency divider 19, and a phase-locked loop (PLL) 20.

The PLL 20 has frequency dividers 14 and 16, a phase comparator 15, a low-pass filter (LPF) 17, and a voltage control oscillator (VCO) 18.

To the serial/parallel converter 1, input data dl having the frame configuration shown in FIG. 2 are input as 1-bit unit serial data. The serial/parallel converter 1 converts these serial data d1 to 8-bit (i.e. 1-byte) parallel data and sends those data to the buffer memory 2 and destuffing control circuit 4.

To the frequency divider 5 is input an input clock signal cl from a previous-stage circuit (not shown). This input clock signal c1 is generated using the input data d1, for example, and has a frequency which is the same as the frequency of the input data d1. That is, 1 clock pulse (1 cycle) of the input clock signal c1 corresponds to 1 bit of the input data d1. When the input data d1 speed is 100 Mbps, for example, the frequency of the input clock signal c1 is 100 MHz.

The frequency divider 5 divides the input clock signal c1 with division ratio 8, and generates a clock signal c2 wherein the 8 clock pulses of the input clock signal c1 have been converted to 1 clock pulse. That is, 1 clock pulse of the clock signal c2 corresponds to 1 byte of the input data d1. This clock signal c2 is input to the write address counter 6 and to the frequency divider 14 of the PLL 20.

The write address counter 6, under the control of the destuffing control circuit 4, in synchronization with the clock signal c2, generates an address signal indicating a write address in the buffer memory 2 and sends the address signal to the buffer memory 2 and the address latch 7. The write address indicated by the address signal is incremented by 1 at every clock pulse of the clock signal c2, and returns to the lowest address after the highest address has been reached.

Here, the buffer memory 2 has a memory capacity of 90 bytes, the same as the payload part of the input data (that is, 90 1-byte-memory-cells). Accordingly, the write address counter 6 sequentially generates address signals for write addresses from 0 to 89, then reverts to 0 after the 89th address and repeats.

Every time an address signal from the write address counter 6 is given (that is, in synchronization with the clock signal c2 of the frequency divider 5), 1 byte of parallel data from the serial/parallel converter 1 is written to (i.e., stored in) the memory cell at the address indicated by the address signal.

When the parallel data from the serial/parallel converter 1 are data in the overhead part (excluding 1 byte of communication data placed in the overhead part when negative stuffing is effected), and when those data are stuff data in the payload part, the destuffing control circuit 4 controls the write address counter 6 so that the write address counter 6 does not output a new address signal and so that it does not increment the write address.

Thereby, the data in the overhead part (excluding 1 byte of communication data placed in the overhead part when negative stuffing is effected) and the stuff data in the payload part are not written to the buffer memory 2, and only the communication data in the payload part and the communication data in the overhead part when negative stuffing is effected are written to the buffer memory 2. In other words, destuffing is effected.

Meanwhile, every time an address signal generated by the read address counter 8 is input, the communication data stored in the buffer memory 2 are read out from the memory cell having the read address indicated by the address signal. The data so read out (1 byte of parallel data) are sent to the parallel/serial converter 3 and converted to serial data (output data) d2. The output data d2 are sent to subsequent-stage circuitry (not shown).

That read address counter 8, synchronized with the clock signal c7 of the frequency divider 9, generates an address signal that indicates a read address in the buffer memory 2, and sends the signal to the buffer memory 2. Accordingly, the communication data stored in the buffer memory 2 are read out in synchronization with the clock signal c7.

The read address indicated by the address signal is incremented by 1 at every clock pulse of the clock signal c7, returning to the lowest address (address 0) after the highest address (address 89) has been reached.

Given that the time required for writing input data to all the memory cells in the buffer memory 2, from address 0 to address 89, is made 1 cycle, when the writing of data to the buffer memory 2 and the reading of data from the buffer memory 2 are in a balanced condition, the read address and write address are set so as to be shifted by ½ cycle. That is, the read address and write address are shifted by 45 addresses, or half the memory capacity of the buffer memory 2. When the read address is 0, for example, the write address will be 45, and when the write address is 0, the read address will be 45. As will be described subsequently, the value of the difference between these two addresses will fluctuate depending on whether positive stuffing or negative stuffing is effected in the input data, and, in order to return this to a steady condition, the count cycle of the read address counter 8 (that is, the cycle or frequency of the clock signal C7) is adjusted by the PLL 20.

The clock signal c7 input to the read address counter 8 is a signal obtained by dividing the output clock signal c6 of the PLL 20 (VCO 18) with division ratio 8. That being so, the speed of the data read-out from the buffer memory 2 (that is, the count cycle of the read address counter 8) is controlled by the PLL 20.

To the PLL 20 are input the clock signal c2 from the frequency divider 5 and the clock signal c5 from the variable frequency divider 19. The clock signal c2 is input to the frequency divider 14, and the clock signal c5 is input to the frequency divider 16.

The frequency divider 14 divides the clock signal c2 with division ratio N and generates the clock signal c3 obtained by converting N clock pulses of the clock signal c2 to one clock pulse. Meanwhile, the frequency divider 16 divides the clock signal c5 with division ratio M, and generates the clock signal c5 obtained by converting M clock pulses of the clock signal c4 to one clock pulse. These clock signals c3 and c6 are input to the phase comparator 15.

The values of the division ratios N and M are set so that the ratio thereof N:M becomes the ratio between the number of bytes in the entire frame and the number of bytes in the payload part of the frame. With the frame configured as shown in FIG. 2, those values are set to N=100 and M=90, for example.

The reason for setting the values of N and M so is that, whereas the input data constitute the entire frame including the overhead part, the data stored in and read out from the buffer memory 2 are data in the payload part of the frame, wherefore the ratio between the frequency of the input clock signal c1 (100 MHz, for example) and the frequency of the output clock signal c6 (90 MHz, for example) is N:M.

The phase comparator 15 converts the phase difference between the clock signals c3 and c4 to a voltage, and sends the voltage signal through the LPF 17 to the VCO 18. The VCO 18 feeds back the clock signal (output clock signal) c6 having a frequency corresponding to the voltage signal sent from the LPF 17 through the variable frequency divider 19 to the frequency divider 16 and sends it also to the frequency divider 9.

The frequency divider 9 divides the output clock signal c4 with division ratio 8, and generates the clock signal c7 obtained by converting 8 clock pulses of the output clock signal c4 to one clock pulse. That is, one clock pulse of the output clock signal c7 corresponds to 1 bit of the output data d2, and one clock pulse of the clock signal c7 corresponds to 1 byte of the output data d2. This clock signal c7 is input to the read address counter 8.

The read address counter 8, when the read address has become 0, outputs a latch signal to the address latch 7. Thereby, the write address of the write address counter 6 at the time when the read address became 0 is temporarily stored in the address latch 7.

The write address stored in the address latch 7 connotes the address difference obtained by subtracting the read address from the write address (=(write address)−(read address)). This address difference stored in the address latch 7 is input to the compensation amount calculator 12.

The compensation amount calculator 12 computes a compensation amount (adjustment amount) from the address difference sent from the address latch 7 and the compensation amount calculation table stored in the compensation amount calculation table memory 10.

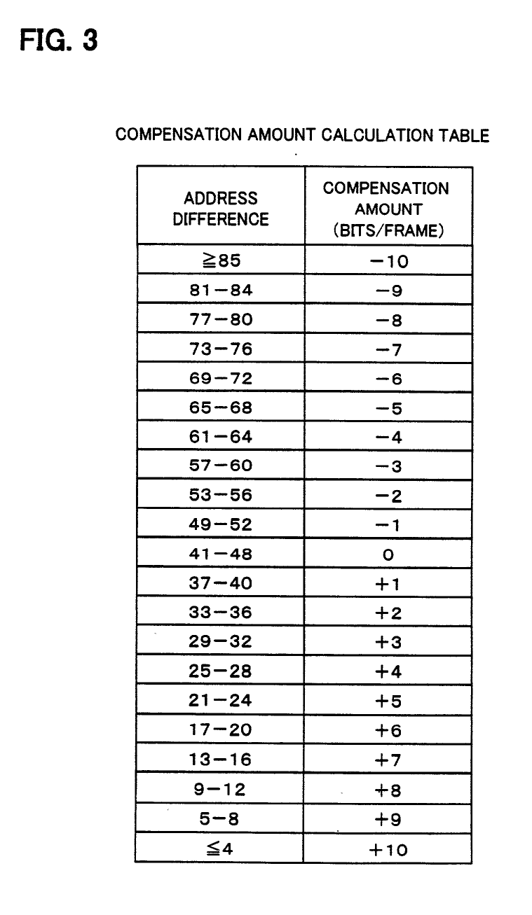

In FIG. 3 is given an example of a compensation calculation table stored in the compensation amount calculation table memory 10. The compensation amount calculation table indicates, in correspondence with address differences sent from the address latch 7, how many times the division ratio of the variable frequency divider 19 is changed from 8 to 9 or from 8 to 7 during the cycle T for one frame of input data d1. Here, by the cycle T for one frame of the input data d1 is meant the time interval from the start of reception to the end of reception of one frame of the input data d1. If one frame has 100 bytes, for example, and the communication speed is 100 Mbps, the cycle T=100×8÷(100×10⁶)=8 [μs].

The “compensation amount (bits/frame)” in the compensation amount calculation table indicates how many times the division ratio of the variable frequency divider 19 is changed from 8 to 9 or from 8 to 7 during the cycle T. The plus sign “+” means that the division ratio is changed from 8 to 7, while the minus sign “−” means that the division ratio is changed from 8 to 9.

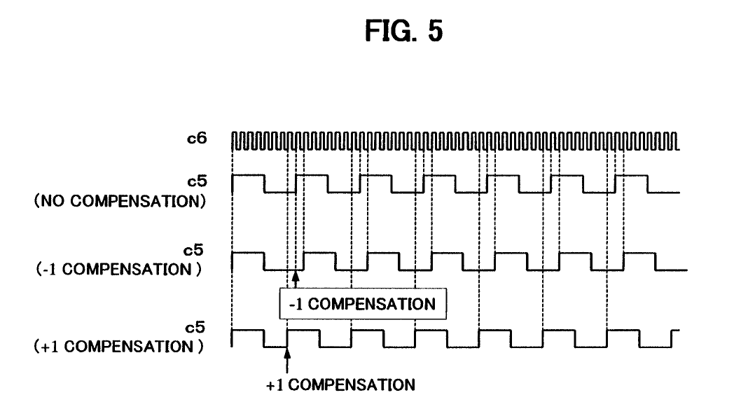

When the address difference is 41 or greater but 48 or less, for example, the compensation amount is 0 [bits/frame]. Accordingly, in this case, the division ratio of the variable frequency divider 19 is not compensated for but maintained at 8. Thus the clock signal c5 obtained by dividing the clock signal c6 with division ratio 8 is generated, as indicated by “c5 (no compensation)” in FIG. 5.

When the address difference is 49 or greater but 52 or less, the compensation amount is −1 [bits/frame]. In this case, the division ratio of the variable frequency divider 19 is changed one time during the cycle T to 8+1=9. Thereby, as indicated by “c5 (−1 compensation)” in FIG. 5, during the cycle T, some one clock pulse of the clock signal c5 becomes that resulting from dividing the clock signal c6 with division ratio 9, while the other clock pulses become that resulting from dividing the clock signal c6 with a division ratio of 8. As a result, the clock signal c5 getting the −1 compensation becomes a signal that is later than the non-compensated clock signal c5 by the measure of 1 cycle of the clock signal c6, wherefore the PLL 20 output frequency will rise, and, in correspondence therewith, the count cycle of the read address counter 8 will become shorter. As a result, the read cycle becomes shorter, and data are read out with a shorter time interval.

Similarly, when the compensation amount is −2 bits/frame, the division ratio of the variable frequency divider 19 is changed from 8 to 9 two times during the cycle T. Thereby, the clock signal c5 getting the −2 compensation becomes a signal that is later than the non-compensated clock signal c5 by the measure of 2 cycles of the clock signal c6, and, in correspondence therewith, the count cycle of the read address counter 8 becomes shorter. As a result, the read cycle becomes shorter, and data are read out with a shorter time interval.

On the other hand, when the compensation amount is +1, for example, as indicated by “c5 (+1 compensation)” in FIG. 5, the clock signal c5 advances by the measure of 1 cycle of the clock signal c6. Thereby, the read cycle becomes longer and the data read-out time interval becomes longer.

The reason for setting the compensation amount to values such as those shown in FIG. 3 for the address differences is now explained.

As described earlier, the difference between the write address and read address is 45 in a balanced condition, wherefore, when the write address stored in the address latch at the time when the read address is 0 is 45 or a value close to 45, the writing of data to and reading of data from the buffer memory 2 will be in a substantially balanced condition. Accordingly, in this case, there is no need to compensate the read-out speed, and the compensation amount is 0.

When the address difference approaches 0, on the other hand, this means that, due to the fact that many frames wherein stuff data have been inserted have been received consecutively, or such like, the cycle wherewith data are written to the buffer memory 2 becomes longer than the cycle wherewith data are read from the buffer memory 2, so that there is a danger that the buffer memory 2 will underflow. That being so, as the address difference approaches 0, the compensation amount is set to larger and larger positive values, as a result whereof the read-out cycle is controlled so as to become longer.

The approach of the address difference to 89 means that the cycle wherewith data are written to the buffer memory 2 is shorter than the cycle wherewith data are read from the buffer memory 2, so that there is a danger that the buffer memory 2 will overflow. Accordingly, as the address difference approaches 89, the compensation amount is set to smaller and smaller negative values, as a result whereof the read-out cycle is controlled so as to become shorter.

The reason why the unit of compensation is “bits/frame” is that one clock pulse of the output clock signal c6 corresponds to one bit of output data, as noted earlier, while one change in the division ratio of the variable frequency divider 19 corresponds to changing the phase of the output data d2 in 1-bit units.

The compensation amount calculator 12, from the compensation amount calculation table, determines the compensation amount corresponding to the address difference sent from the address latch 7, and sends the compensation amount to the compensation control circuit 13. Also, the address difference stored in the address latch 7 is updated every time the read address becomes 0, wherefore the compensation amount will also be updated every time the read address becomes 0.

The compensation control circuit 13, based on the compensation amount sent from the compensation amount calculator 12 and the compensation pattern table stored in the compensation pattern table memory 11, determines the timing for changing the division ratio of the variable frequency divider 19 (i.e., the compensation timing), and, at the changing timing so determined, changes the division ratio of the variable frequency divider 19 to either 7 or 9.

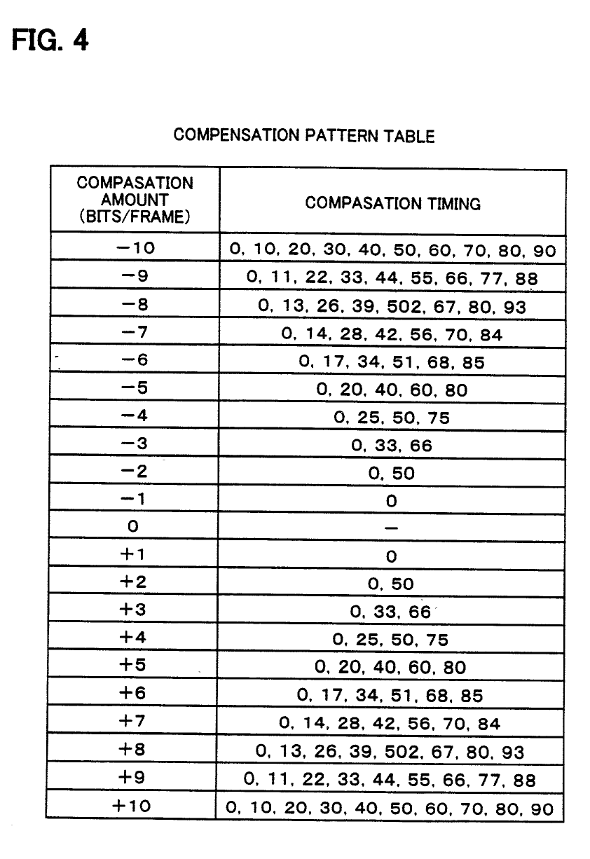

FIG. 4 shows an example of a compensation pattern table. The compensation pattern table is a table that represents the correlation between the compensation amounts provided from the compensation amount calculator 12 and the timing wherewith the compensations (changes in division ratio of variable frequency divider 19) are made.

The timing wherewith compensations are made (hereinafter called “compensation timing”) indicates the point in time a compensation is made by the receiving position of each byte in one frame (100 bytes) of the input data d1. The compensation timing 0, for example, indicates that compensation is made at the time when the beginning byte of one frame is received, while the compensation timing 50 indicates that compensation is made at the time when the 50th byte of one frame is received.

This compensation timing, when compensation is performed a plurality of times, is set, as diagrammed in FIG. 4, so that the time intervals for making compensation a plurality of times become substantially equivalent. By changing the division ratio of the variable frequency divider 19 in this manner, that is, not by a large measure at one time, but rather within a range of +1 distributed over one frame, very rapid changes in the frequency of the output clock signal c6 of the PLL 20 can be prevented, and, as a consequence, the level of jitter generated can be reduced.

Furthermore, the minimum value of the compensation amount is 1 bit/frame, whereupon the frequency of compensation becomes equivalent to the case where 8-frame smoothing is performed with the conventional smoothing circuit described earlier.

To the compensation control circuit 13, moreover, a signal (such as a frame synchronizing pulse signal, for example) indicating the position of the frame is input over a signal line (not shown), and, by the signal, the compensation control circuit 13 can determine the compensation timing.

As described in the foregoing, based on this embodiment, the amount of jitter generated can be reduced.

Based on this embodiment, moreover, in order to implement a receiver apparatus, there is no need for complex circuitry and the circuit scale can be made small. In addition, because the cycle of the address latch 7 can be made short and because the read-out cycle is controlled on the basis of the address difference of the buffer memory 2, receiver apparatus response becomes faster.

That is, there is no need for the buffer memory 2 to have the capacity to store the data of a plurality of frames, but may have the capacity to store the data of one frame or a smaller capacity, whereupon there is no need to provide a large scale memory device for the buffer memory 2. For the compensation amount calculation table memory 10 and the compensation pattern table memory 11, moreover, it is only necessary to provide memory devices of such size as to enable the tables diagrammed in FIG. 3 and FIG. 4, respectively, to be stored. Furthermore, the address latch 7 need only be able to latch one address, and the compensation amount calculator 12 can be configured with a circuit that retrieves from the compensation amount calculation table that which corresponds to the address stored in the address latch 7. And the compensation control circuit 13 need only be such as will convert (set) the division ratio of the variable frequency divider 19 to 7 or 9 in a prescribed time interval.

Based on this embodiment, moreover, the frequency of the output clock signal of the PLL 20 is controlled on the basis of the address difference between the write address and the read address, wherefore the read-out speed is adjusted according to the condition wherein data are stored in the buffer memory 2. Hence data can be sent on to the subsequent-stage circuitry without a pause.

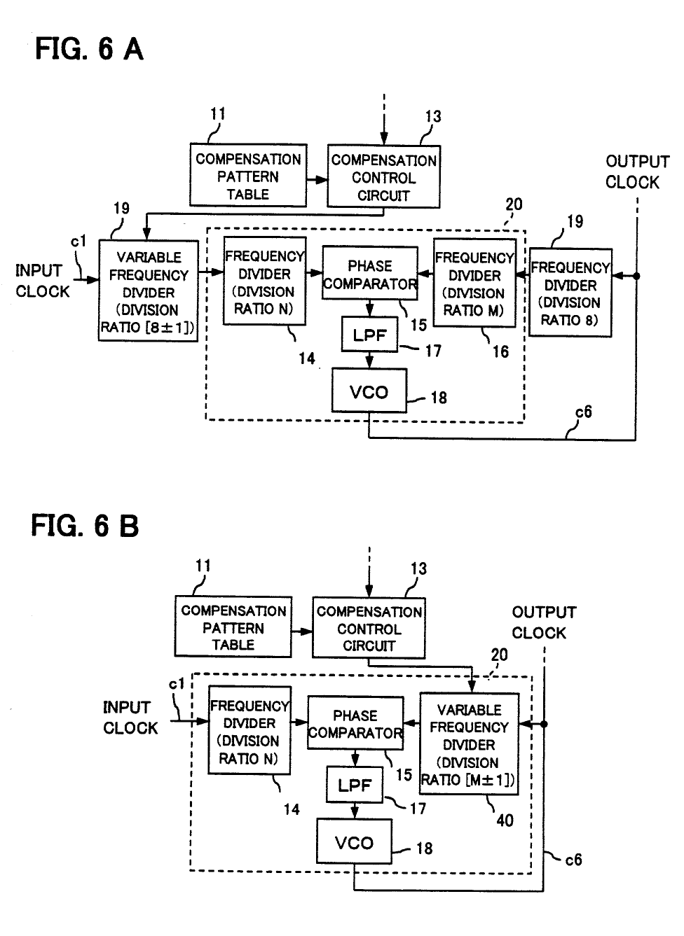

As another embodiment, the variable frequency divider 19 can be deployed in a stage prior to the frequency divider 14 as shown in FIG. 6A. In this case, to the variable frequency divider 19 deployed in a stage prior to the frequency divider 14, the input clock signal cl is input, and, in the place where the variable frequency divider 19 was deployed in FIG. 1, a frequency divider 30 having a division ratio of 8 is newly provided.

Alternatively, as shown in FIG. 6B, the variable frequency divider 19 and frequency divider 16 can be configured as a single variable frequency divider 40 (having a division ratio of M or M±1). In this case, to the frequency divider 14, the input clock signal cl will be input directly, while to the variable frequency divider 40, the output clock signal c6 of the VCO 18 will be input directly. It is also possible to deploy this variable frequency divider on the input clock signal side, making the frequency divider 14 to which the input clock signal cl is input a variable frequency divider (having a division ratio of N or N±1), and giving the frequency divider to which the output clock signal c6 is input a division ratio of M (fixed).

The address latch 7 may also be a subtractor that subtracts the read address from the write address.

It is also possible to use a fractional frequency divider that can take the division ratio as a fractional value for the variable frequency divider 19 or 40. In this case, even if the compensation amount is ±1 bit/frame, that compensation amount can be equally divided n times (where n is an integer 2 or greater), and the division ratio of the variable division ratio changed by ±1/n at a time for n compensation timings.

In this embodiment aspect, the description assumed 1 byte of stuff data, but the present invention can be applied in cases of 1 bit or a plurality of bits of stuff data, or in cases of 2 or more bytes thereof.

Based on the present invention, the size of receiver apparatus circuitry can be made smaller. Based on the present invention, moreover, jitter can be prevented by distributing the adjustment (compensation) of the cycle (frequency) of the read clock signal with a plurality of timings.

What is claimed is:

1. A receiver apparatus for receiving digital data in which stuff data have been inserted by stuffing synchronization, comprising:
a memory unit having a plurality of memory cells to which consecutive addresses are assigned;
a write unit for sequentially designating said addresses in a prescribed order direction and for writing said digital data to the memory cells at the designated addresses, in synchronization with a write clock signal generated on basis of a clock signal synchronized with said digital data;
a write controller for prohibiting said write unit from designating said address at least for said stuff data and from writing at least stuff data;
a read clock signal generator for generating a read clock signal used for reading out digital data stored in said memory unit;
a read unit for sequentially designating said addresses in said memory unit in said prescribed order direction and for reading out digital data stored in memory cells at the designated addresses in synchronization with said read clock signal; and
a read clock signal regulator for adjusting a cycle of said read clock signal based on an interval in said prescribed order direction from an address designated by said read unit to an address designated by said write unit.

2. The receiver apparatus according to claim 1, wherein said read clock signal regulator performs adjustment of said read clock signals in parts at a plurality of adjustment timings.

3. The receiver apparatus according to claim 1, wherein said read clock signal regulator maintains a current read clock signal cycle when the interval in said prescribed order direction is a predetermined interval, makes a cycle of said read clock signal longer than the current cycle when said interval is shorter than said predetermined interval, and makes a cycle of said read clock signal shorter than the current cycle when said interval is longer than said predetermined interval.

4. The receiver apparatus according to claim 1, wherein said read clock signal regulator holds a first table and a second table, and adjusts the cycle of said read clock signal on basis of said first and second tables, said first table associating the interval in said prescribed order direction and an adjustment amount for said cycle, said second table setting a timing for adjusting said cycle by said adjustment amount in one adjustment, or, alternatively, setting timings for adjusting said cycle by dividing said adjustment amount into a plurality, and executing a plurality of adjustments each by said divided adjustment amount.

5. The receiver apparatus according to claim 4, wherein intervals between said plurality of timings in said second table are substantially equal time intervals.

6. The receiver apparatus according to claim 4, wherein said read clock signal generator comprises:
a phase-locked loop circuit having as input signals said write clock signal and a signal resulting from dividing its own output signal with a variable frequency divider; and
a frequency divider for dividing an output signal of said phase-locked loop circuit with a division ratio of the same numerical value as the number of bits held in each of said memory cells, and sending the divided signal to said read unit; and wherein
said read clock signal regulator increments or decrements a division ratio of said variable frequency divider by 1 from the division ratio of the same numerical value as the number of said bits, and thereby adjusts the cycle of said read clock signal.

7. The receiver apparatus according to claim 4, wherein said read clock signal generator comprises:
a phase-locked loop circuit; and
a frequency divider having a division ratio of the same numerical value as the number of bits held in each of said memory cells, and for sending a divided signal to said read unit;
said phase-locked loop circuit has as input signals a signal resulting from division by a variable frequency divider of an input clock signal having the same frequency as receiving speed of said digital data, and output signal of said frequency divider; and wherein
said read clock signal regulator increments or decrements a division ratio of said variable frequency divider by 1 from a division ratio of the same numerical value as said number of bits, and thereby adjusts the cycle of said read clock signal.

8. The receiver apparatus according to claim 6, wherein said digital data are received in units of frames having a payload part and an overhead part; said payload part having communication data to be written to said memory unit and, when positive stuffing is effected, said stuff data; said overhead part having control data and, when negative stuffing is effected, communication data that should be contained in said payload part;
said write controller prohibits said write unit from said address designation and from writing data, for the stuff data in the payload part and all those data other than the communication data in said overhead part;
said phase-locked loop comprises:
a first frequency divider for dividing said write clock signal with a division ratio of N;
a second frequency divider for dividing an output signal of said variable frequency divider with a division ratio of M;
a phase comparator for finding phase difference between output signals of said first frequency divider and said second frequency divider;
a low-pass filter for filtering an output signal of said phase comparator; and
a voltage control oscillator to which is input signal filtered by said low-pass filter; and
said N and M are any numerical values with which N:M becomes equivalent to the ratio between data volume of said overhead part and data volume of said payload part.

9. The receiver apparatus according to claim 7, wherein said digital data are received in units of frames having a payload part and an overhead part; said payload part having communication data to be written to said memory unit and, when positive stuffing is effected, said stuff data; said overhead part having control data and, when negative stuffing is effected, communication data that should be contained in said payload part;
said write controller prohibits said write unit from designating said address and from writing data, for the stuff data in the payload part and all those data other than the communication data in said overhead part;
said phase-locked loop comprises:
a first frequency divider for dividing said write clock signal with a division ratio of N;
a second frequency divider for dividing an output signal of said variable frequency divider with a division ratio of M;
a phase comparator for finding phase difference between output signals of said first frequency divider and said second frequency divider;
a low-pass filter for filtering an output signal of said phase comparator; and
a voltage control oscillator to which is input signal filtered by said low-pass filter; and
said N and M are any numerical values with which N:M becomes equivalent to a ratio between data volume of said overhead part and data volume of said payload part.

10. The receiver apparatus according to claim 4, wherein said digital data are received in units of frames having a payload part and an overhead part; said payload part having communication data to be written to said memory unit and, when positive stuffing is effected, said stuff data; said overhead part having control data and, when negative stuffing is effected, communication data that should be contained in said payload part;
said write controller prohibits said write unit from designating said address and from writing data, for the stuff data in the payload part and all those data other than the communication data in said overhead part;
said read clock signal generator comprises:
a voltage control oscillator;
a first frequency divider for dividing an input clock signal having the same frequency as said digital data with a division ratio of N;
a second frequency divider for dividing an output signal of said voltage control oscillator with a division ratio of M or a division ratio of M+1;
a phase comparator for finding phase difference between output signals of said first frequency divider and said second frequency divider;
a low-pass filter for filtering an output signal of said phase comparator and sending a filtered signal to said voltage control oscillator; and
a third frequency divider for dividing the output signal of said voltage control oscillator with a division ratio of the same numerical value as the number of bits held in each of the memory cells, and sending a divided signal as said read clock signal to said read unit;
said N and M are any numerical values with which N:M becomes equivalent to a ratio between data volume of said overhead part and data volume of said payload part; and
said read clock signal regulator increments or decrements the division ratio of said second frequency divider by 1 from said M, and thereby changes the cycle of said read clock signal.

11. The receiver apparatus according to claim 4, wherein said digital data are received in units of frames having a payload part and an overhead part; said payload part having communication data to be written to said memory unit and, when positive stuffing is effected, said stuff data; said overhead part having control data and, when negative stuffing is effected, communication data that should be contained in said payload part;
said write controller prohibits said write unit from designating said address and from writing data, for the stuff data in the payload part and all those data other than the communication data in the overhead part;
said read clock signal generator comprises:
a voltage control oscillator;
a first frequency divider for dividing an input clock signal having the same frequency as said digital data with a division ratio of N or a division ratio of N±1;
a second frequency divider for dividing an output signal of said voltage control oscillator with a division ratio of M;
a phase comparator for finding phase difference between output signals of said first frequency divider and said second frequency divider;
a low-pass filter for filtering an output signal of said phase comparator and sending a filtered signal to said voltage control oscillator; and
a third frequency divider for dividing the output signal of said voltage control oscillator with a division ratio of the same numerical value as the number of bits held in each of the memory cells, and sending a divided signal as said read clock signal to said read unit;
said N and M are any numerical values wherewith N:M becomes equivalent to a ratio between data volume of said overhead part and data volume of said payload part; and
said read clock signal regulator increments or decrements the division ratio of said first frequency divider by 1 from said N, and thereby changes the cycle of said read clock signal.
